(19) United States
(12) Patent Application Publication
(10) Pub. No.: US 2016/0012933 A1
(43) Pub. Date: Jan. 14, 2016

(54) Composite Formulation and Composite Product

(71) Applicant: Tyco Electronics Corporation, Berwyn, PA (US)

(72) Inventors: Jaydip Das, Cupertino, CA (US); Ting Gao, Palo Alto, CA (US); Jialing Wang, Mountain View, CA (US); Nicola Pugliano, Redwood City, CA (US); Kavitha Bharadwaj, Fremont, CA (US); Richard B. Lloyd, Sunnyvale, CA (US)

(73) Assignee: Tyco Electronics Corporation, Berwyn, CA (US)

(21) Appl. No.: 14/329,654

(22) Filed: Jul. 11, 2014

(51) Int. Cl. H01B 1/22

(52) U.S. Cl. CPC H01B 1/22

(57) ABSTRACT

A composite formulation and composite product are disclosed. The composite formulation includes a polymer matrix, tin-containing particles blended within the polymer matrix at a concentration, by weight, of at least 25%, copper-containing particles blended within the polymer matrix at a concentration, by weight, of at least 40%, and one or both of solder flux and density-lowering particles blended into the polymer matrix. The tin-containing particles and the copper-containing particles have one or more intermetallic phases from metal-metal diffusion of the tin-containing particles and the copper-containing particles being blended at a temperature within the intermetallic annealing temperature range for the tin-containing particles and the copper-containing particles.

### FIELD OF THE INVENTION

The present invention is directed to formulations and manufactured products. More particularly, the present invention is directed to composite formulations and composite products formed from such composite formulations for use in electrical components.

### BACKGROUND OF THE INVENTION

Electrically conductive materials are useful in a variety of components. Lowering the resistivity and, thus, increasing the conductivity is desirable for improving such components. Extending the useful life of such components is also desirable. Further improvements to such components permit wider use in different environmental conditions.

Copper particles can be used in materials to produce relatively good electrically conductive composite formulations. However, such materials are not capable of use in certain applications due to copper's susceptibility to oxidation and consequently the loss of conductivity of the composite materials. In addition, such materials are not as conductive as materials including silver. However, silver is expensive and may not be practical for certain applications for economic reasons.

Molded and/or extruded products have not previously been available with low density and a low resistivity. Further reductions in the weight of products can produce numerous additional benefits.

Decreasing resistivity and, thus, increasing conductivity of materials, without sacrificing cost, operational complexity, or functional properties continues to be desirable in the art.

A composite formulation and composite product that shows one or more improvements in comparison to the prior art would be desirable in the art.

### BRIEF DESCRIPTION OF THE INVENTION

In an embodiment, a composite product formed from a composite formulation includes a polymer matrix, tin-containing particles blended within the polymer matrix at a concentration, by weight, of at least 25%, copper-containing particles blended within the polymer matrix at a concentration, by weight, of at least 40%, and solder flux blended into the polymer matrix at a concentration, by weight, of at least 1% for reducing or eliminating oxides in the copper-containing particles. The tin-containing particles and the copper-containing particles have one or more intermetallic phases from metal-metal diffusion of the tin-containing particles and the copper-containing particles being blended at a temperature within the intermetallic annealing temperature range for the tin-containing particles and the copper-containing particles.

In another embodiment, a composite product formed from a composite formulation includes a polymer matrix, tin-containing particles blended within the polymer matrix at a concentration, by weight, of at least 13%, copper-containing particles blended within the polymer matrix at a concentration, by weight, of at least 25%, and density-lowering particles blended into the polymer matrix at a concentration, by weight, of between 3% and 15%. The tin-containing particles and the copper-containing particles have intermetallic phases from metal-metal diffusion of the tin-containing particles and the copper-containing particles being blended at a temperature within the intermetallic annealing temperature range for the tin-containing particles and the copper-containing particles.

In another embodiment, a composite formulation includes a polymer matrix, tin-containing particles blended within the polymer matrix at a concentration, by weight, of between 13% and 31%, one or more shapes of copper-containing particles blended within the polymer matrix at a concentration, by weight, of between 25% and 56%, and one or both of solder flux and density-lowering particles blended into the polymer matrix. The tin-containing particles and the copper-containing particles have intermetallic phases from metal-metal diffusion of the tin-containing particles and the copper-containing particles being blended at a temperature within the intermetallic annealing temperature range for the tin-containing particles and the copper-containing particles.

Other features and advantages of the present invention will be apparent from the following more detailed description, taken in conjunction with the accompanying drawings which illustrate, by way of example, the principles of the invention.

### BRIEF DESCRIPTION OF THE DRAWINGS

FIG. 1 is a schematic view of a composite formulation having a polymer matrix and particles, according to an embodiment of the disclosure.

FIG. 2 is a perspective view of an EMI shield that is a composite product formed from a composite formulation, according to an embodiment of the disclosure.

FIG. 3 is a perspective view of an electrical connector that is a composite product formed from a composite formulation, according to an embodiment of the disclosure.

FIG. 4 is a perspective view of an antenna that is a composite product formed from a composite formulation, according to an embodiment of the disclosure.

Wherever possible, the same reference numbers will be used throughout the drawings to represent the same parts.

### DETAILED DESCRIPTION OF THE INVENTION

Provided are a composite formulation and a composite product produced from a composite formulation. Embodiments of the present disclosure, for example, in comparison to similar concepts failing to disclose one or more of the features disclosed here, have lower viscosity (for example, in comparison to neat versions of the polymer matrix that include no metal particles), have a higher concentration of filled constituents, have lower resistivity (and higher electrical conductivity), are more processable (for example, capable of being extruded and/or molded), have homogeneously dispersed particles forming a conductive network within the polymer matrix, have high conductivity by selecting morphologies and aspect ratios of metal particles and the loading levels of such particles without compromising the processability, have increased oxidation inhibition and extended operational life (for example, based upon aging data), and/or are capable of other advantages and distinctions apparent from the present disclosure.

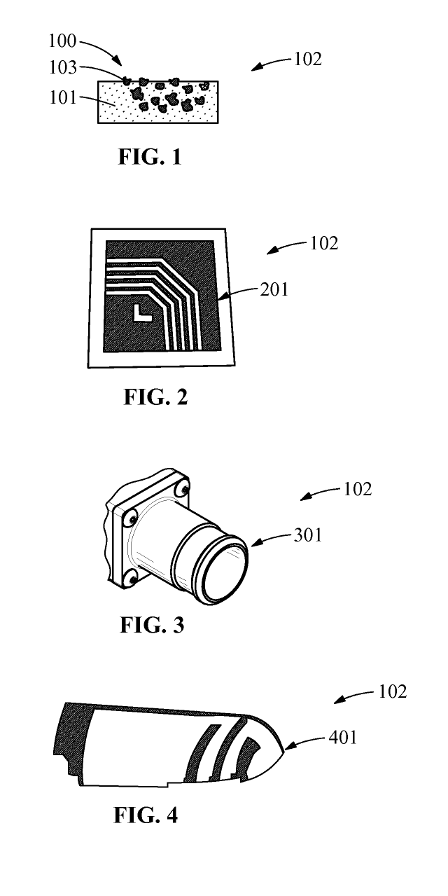

Referring to FIG. 1, a composite formulation 100 includes a polymer matrix 101 and particles 103. The particles 103 are process-aid-treated and blended within the polymer matrix 101. The particles 103 include copper-containing particles, for example, at a concentration, by weight, of at least 40% (for example, between 40% and 75%, between 50% and 55%, or any suitable combination, sub-combination, range, or sub-range therein), and tin-containing particles, for example, at a concentration, by weight, of at least 25% (for example, between 25% and 50%, at least 27% or between 27% and 31%, or any suitable combination, sub-combination, range, or sub-range therein). The copper-containing particles and/or the tin-containing particles include copper and/or tin, respectively, at a concentration of at least 90%, by weight, for example, at 95%.

The polymer matrix 101 includes any suitable constituents blended within to lower density of the composite formulation 100. In one embodiment, such constituents includes hollow or solid glass and/or polymer spheres (for example, at a concentration, by weight, of between 5% and 10% of the composite formulation 100), thereby reducing the density of the composite formulation 100, for example, by at least 30% and/or by at least 2 gm/cm³. As used herein, the term “sphere” is intended to cover spheres, spheroid particles, or other particles that generally resemble a sphere but may or may not be perfect spheres. In one embodiment, such constituents include carbon black (for example, at a concentration, by weight, of between 7% and 15% or between 13% and 15% of the composite formulation 100) and/or solder flux, which each also includes a resistivity-lowering effect.

The carbon black blended within the polymer matrix 101 is independent or within a particulate conductive filler. As a particulate conductive filler, the carbon black is present with other particulate conductive materials such as graphite, metal, metal oxide, conductive coated glass or ceramic beads, particulate conductive polymer, or a combination of these. Such particulate conductive fillers are capable of being in the form of powder, beads, flakes, or fibers. In one embodiment, the particulate filler consist essentially of carbon black that has a DBP number of 60 to 120 cm³/100 g, 60 to 100 cm³/100 g, 60 to 90 cm³/100 g, 65 to 85 cm³/100 g, or any suitable combination, sub-combination, range, or sub-range therein. The DBP number is an indication of the amount of structure of the carbon black and is determined by the volume of n-dibutyl phthalate (DBP) absorbed by a unit mass of carbon black. This test is described in ASTM D2414-93, the disclosure of which is incorporated herein by reference.

The solder flux (not shown) blended within the polymer matrix 101 is an organic acid, for example, at a concentration of at least 0.2% or at least 1% of the composite formulation 100. The solder flux reduces or eliminates the formation of oxides on the copper-containing particles. Upon blending the solder flux and/or the glass/polymer spheres within the polymer matrix 101, in one embodiment, the composite formulation 100 has a viscosity that is lower than the viscosity of the polymer matrix 101 without the blending.

The particles 103, the spheres, the solder flux, the carbon black, the polymer matrix 101 or a combination thereof reduces a percolation threshold to a decreased percolation threshold. As used herein, the phrase “decreased percolation threshold” refers to being compared to a similar composition that fails to include the particles 103. In one embodiment, the percolation threshold is between 20% and 30%, for example, with a concentration being between 20% and 30% by volume, of the particles 103 in the composite formulation 100.

The blending of the composite formulation 100 is by any suitable technique capable of being achieved within the intermetallic annealing temperature range of the particles 103, such as twin-screw extrusion or bowl mixing, thereby producing intermetallics. In one embodiment, the particles 103 further include additional types of metals or metallics, such as, aluminum, stainless steel, silver, nickel, metallic alloys including such materials, or a combination thereof, which may or may not be further constituents of the intermetallics.

Although not intending to be bound by theory, the resistivity of the composite formulation 100 is at least partially based upon metal-metal diffusion of the particles 103. Upon the particles 103 being processed within the composite formulation 100, it is believed that the tin-containing particles and the copper-containing particles generate one or more intermetallic phases from metal-metal diffusion of the tin-containing particles and the copper-containing particles. The intermetallic phases are generated by the blending being at a temperature within the intermetallic annealing temperature range for the tin-containing particles and the copper-containing particles. As used herein the term “intermetallic annealing temperature range” refers to a temperature fostering metal-metal diffusion, for example, as shown in a phase diagram capable of being produced for the specific compositional constituents. In one embodiment, such intermetallic phases include an e-phase, an n-phase, correspond with the liquid-solidus plot for copper-tin intermetallics, or a combination thereof. Additionally or alternatively, in one embodiment, the intermetallic phases include intermetallics such as Cu₃Sn, Cu₆Sn₅, or combinations thereof.

The polymer matrix 101 includes any suitable material capable of having the particles 103 blended within it. Suitable materials include, but are not limited to, fluoropolymers (for example, polyvinylidene fluoride (PVDF), PVDF/hexafluoropropylene (HFP) copolymer, PVDF/HFP tetrafluoroethylene (TFE) terpolymer, fluorinated ethylene propylene (FEP), ethylene tetrafluoroethylene (ETFE)), polyethylene (PE), polypropylene (PP), polyethylene terephthalate, polybutylene terephthalate (PBT), liquid crystalline polymer (LCP), polycarbonate (PC), polyamide (PA), and polyphenylene sulfide (PPS). The polymer matrix 101 permits the composite formulation 100 to be extruded, molded (for example, injection molded, compression-molded, and/or vacuum formed), or a combination thereof.

The composite formulation 100 includes any other suitable constituents for processability. In one embodiment, a process aid is blended within the polymer matrix 101, for example, at a concentration, by weight, of between 2% and 4%. In one embodiment, the process aid is dioctyl sebacate (DOS). In another embodiment, the process aid is a polyester plasticizer. In one embodiment, the process aid is tumble blended onto the particles 103 prior to the addition to the polymer matrix 101. Other suitable constituents capable of being blended within the polymer matrix 101 include, but are not limited to, a lubricant (for example, steric acid, or oleic acid), a crosslinking agent, an antioxidant, a metal deactivator, a coupling agent, a curing agent (for example, for chemical curing and/or for radiation curing), a wetting agent, a flame retardant, a pigment or dye, or the combination thereof.

The particles 103 include any suitable dimensions for the blending. In one embodiment, the copper-containing particles and the tin-containing particles differ in size. For example, in one embodiment, the copper-containing particle has a maximum dimension of less than 3 millimeters, less than 2 millimeters, between 0.5 millimeters and 1.5 millimeters, or any suitable combination, sub-combination, range, or sub-range therein. As used herein, the term “maximum dimension” refers to the largest linear measurement. Additionally or alternatively, in one embodiment, the copper-containing particle has a maximum width of less than 300 micrometers, less than 200 micrometers, less than 100 micrometers, between 25 micrometers and 50 micrometers, or any suitable combination, sub-combination, range, or sub-range therein. As used herein, the term “maximum width” refers to a linear measurement that is perpendicular or substantially perpendicular to the maximum dimension.

The particles 103 include any suitable morphologies for the blending. Suitable morphologies include, but are not limited to, dendrites, spheroid particles, flakes, fibers (for example, having aspect ratios of between 5 and 30), wool (for example, having aspect ratios of between 10 and 60 or between 20 and 100), or a combination thereof. In one embodiment, the copper-containing particles include dendrites, flakes, fibers, or a combination thereof. In one embodiment, the tin-containing particles include flakes, include dendrites, are spheroid, or include and/or are a combination thereof. In one embodiment, the particles 103 include two morphologies (thereby being binary), three morphologies (thereby being ternary), or four morphologies (thereby being quaternary). In further embodiments, a portion, substantially all, or all of the particles 103 include aspect ratios above a select aspect ratio, for example, above 5, above 10, above 20, above 30, between 10 and 100, or any suitable combination, sub-combination, range, or sub-range therein.

The composite formulation 100 includes a select resistivity. In one embodiment, the select resistivity is an electrical resistivity of between 3×10E-5 ohm·cm and 7×10E-5 ohm·cm or between 5×10⁻⁵ ohm·cm and 7×10⁻⁵ ohm·cm. In another embodiment, the select resistivity is a bulk resistivity of less than 0.0004 ohm·cm at 23° C. and contact resistance of less than 500 milliohms measured at 200 grams force per ASTM B539-02, at 30% by volume of process-aid-treated metal particles in a composite formulation, with processability suitable for extrusion or molding. Based upon such a conductivity and processability, the composite formulation 100 is capable of being used in a composite product 102, for example, an EMI shield 201 (see FIG. 2), an electrical connector 301 (see FIG. 3) such as an integrated connector, an antenna 401 (see FIG. 4), or another suitable electronic device.

### EXAMPLES

In Examples 1 through 16, composite formulations are blended as shown in Table 1 below:

TABLE 1

| | | | | | | | Density- | | |
|---|---|---|---|---|---|---|---|---|---|
| | | | Tin | Polymer | | Solder | lowering | | |
| | Copper | | Powder | Matrix | DOS | Flux | Particle | Resistivity | Density |
| Example | (wt %) | | (wt %) | (wt %) | (wt %) | (wt %) | (wt %) | (ohm · cm) | (g/cm³) |
| 1PVDF) | 26% | (fiber) | 14% | 49% | 3.0% | | 7.0% | 1.0E−02 | 2.1 |
| 2(PVDF) | 27% | (fiber) | 15% | 44% | 4.0% | 1.0% | 9.0% | 7.0E−04 | 2.1 |
| 3(PVDF) | 33% | (fiber) | 18% | 39% | 3.5% | | 6.5% | 1.0E−03 | 2.4 |
| 4(LCP) | 33% | (fiber) | 18% | 39% | 3.5% | | 6.5% | 1.0E−03 | 2.4 |
| 5(PVDF) | 33% | (fiber) | 19% | 37% | 3.0% | 1.0% | 7.0% | 9.0E−05 | 2.1 |
| 6(PVDF) | 47% | (fiber) | 26% | 27% | | | | 4.0E−05 | 4.3 |
| 7(PVDF) | 47% | (wool) | 26% | 27% | | | | 6.0E−05 | 4.3 |
| 8(PVDF) | 34% | (fiber) | 19% | 30% | 3.0% | | 14.0% | 1.0E−03 | 3 |
| 9(Nylon) | 47% | (fiber) | 26% | 26% | 2.0% | | | 1.0E−03 | |
| 10(PVDF) | 49% | (fiber) | 27% | 22% | 2.0% | | | 2.5E−05 | 4.3 |
| 11(PVDF) | 49% | (wool) | 27% | 22% | 2.0% | | | 4.0E−05 | 4.3 |
| 12(PE) | 55% | (fiber) | 30% | 13% | 2.0% | | | 4.0E−05 | |
| 13(PE) | 55% | (wool) | 30% | 13% | 2.0% | | | 6.0E−05 | |
| 14(PBT) | 54% | (fiber) | 30% | 16% | | | | 5.0E−05 | 4 |
| 15(PVDF) | 25% | (fiber) | 27% | 22% | 2.0% | | | 8.0E−05 | 4 |
| | 24% | (dendrite) | | | | | | | |
| 16(PVDF) | 28% | (fiber) | 21% | 25% | 1.0% | | | 8.0E−05 | 4 |
| | 25% | (dendrite) | | | | | | | |

The copper in Table 1 refers to copper-containing particles having a composition, by weight, of at least 90% elemental copper. The tin in Table 1 refers to tin-containing powder having a composition, by weight, of 90% elemental tin. The copper fiber refers to particles having a diameter of between 100 and 300 micrometers. The copper wool refers to particles having a diameter of less than 100 micrometers. Hollow glass spheres as the density-lowering particles corresponding with Examples 1-5 have an average diameter of about 25 micrometers. The density-lowering particles of Example 7 are carbon black.

Examples 1 through 5 show the density-lowering effect of including hollow spheres in the composite formulation 100. Example 7 shows the density-lowering effect and the resistivity-decreasing effect of including carbon black in the composite formulation 100. Examples 2 and 5 show the resistivity-decreasing effect of including solder flux in the composite formulation 100. Examples 6-7 and 9-15, in comparison to Examples 1-5, 8, and 16 show the effect on the composite formulation 100 of including tin at a concentration, by weight, of greater than 25%. Examples 6-7 and 9-16, in comparison to Examples 1-5 and 8 show the effect on the composite formulation 100 of including copper at a concentration, by weight, of greater than 40%.

While the invention has been described with reference to one or more embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims. In addition, all numerical values identified in the detailed description shall be interpreted as though the precise and approximate values are both expressly identified and all compositional elements are to be interpreted as including or being devoid of incidental impurities.

What is claimed is:

1. A composite product formed from a composite formulation, the composite formulation comprising:
a polymer matrix;
tin-containing particles blended within the polymer matrix at a concentration, by weight, of at least 25%;
copper-containing particles blended within the polymer matrix at a concentration, by weight, of at least 40%; and
solder flux blended into the polymer matrix at a concentration, by weight, of at least 0.2% for reducing or eliminating oxides in the copper-containing particles;
wherein the tin-containing particles and the copper-containing particles have one or more intermetallic phases from metal-metal diffusion of the tin-containing particles and the copper-containing particles being blended at a temperature within the intermetallic annealing temperature range for the tin-containing particles and the copper-containing particles.

2. The composite formulation of claim 1, wherein the polymer matrix comprises dioctyl sebacate at a concentration in the composite formulation, by weight, of between 2% and 4%

3. The composite formulation of claim 1, wherein the tin-containing particles are at a concentration, by weight, of between 27% and 31%.

4. The composite formulation of claim 1, wherein the copper-containing particles are at a concentration, by weight, of between 50% and 55%.

5. The composite formulation of claim 1, wherein the copper-containing particles include copper fibers and copper dendrites, the copper fibers being at a concentration of at least 25% of the composite formulation and the copper dendrites being at a concentration, by weight, of at least 24% of the composite formulation.

6. The composite formulation of claim 1, wherein the composite formulation has a viscosity after blending of the tin-containing particles, the copper-containing particles, and the solder flux that is lower than the polymer matrix viscosity without the blending.

7. The composite formulation of claim 1, wherein the polymer matrix includes polyvinylidene fluoride.

8. The composite formulation of claim 1, further comprising density-lowering particles in the form of glass spheres blended into the polymer matrix at a concentration, by weight, of between 3% and 10%.

9. The composite formulation of claim 1, further comprising carbon black blended into the polymer matrix at a concentration, by weight, of between 7% and 15%.

10. The composite formulation of claim 1, wherein the composite formulation has an electrical resistivity of between 3×10⁻⁵ ohm·cm and 7×10⁻⁵ ohm·cm.

11. The composite formulation of claim 1, wherein the copper-containing particles have a maximum length of less than 3 millimeters.

12. The composite formulation of claim 1, wherein the copper-containing particles have a maximum length of 0.5 millimeters to 1.5 millimeters.

13. The composite formulation of claim 1, wherein the copper-containing particles have a maximum width of less than 300 micrometers.

14. The composite formulation of claim 1, wherein the copper-containing particles have a maximum width of less than 200 micrometers.

15. The composite formulation of claim 1, wherein the copper-containing particles have a maximum width of less than 100 micrometers.

16. The composite formulation of claim 1, wherein the copper-containing particles have a maximum width of between 25 micrometers and 50 micrometers.

17. The composite formulation of claim 1, wherein the intermetallic phases include phases are selected from the group consisting of an ε-phase, an η-phase, and combinations thereof.

18. The composite formulation of claim 1, wherein the intermetallic phases include intermetallics are selected from the group consisting of an Cu₃Sn, Cu₆Sn₅, and combinations thereof.

19. A composite product formed from a composite formulation, the composite formulation comprising:
a polymer matrix;
tin-containing particles blended within the polymer matrix at a concentration, by weight, of at least 13%;
copper-containing particles blended within the polymer matrix at a concentration, by weight, of at least 40%;
density-lowering particles blended into the polymer matrix at a concentration, by weight, of between 3% and 15%; and
wherein the tin-containing particles and the copper-containing particles have intermetallic phases from metal-metal diffusion of the tin-containing particles and the copper-containing particles being blended at a temperature within the intermetallic annealing temperature range for the tin-containing particles and the copper-containing particles.

20. A composite formulation, comprising:
a polymer matrix;
tin-containing particles blended within the polymer matrix at a concentration, by weight, of between 13% and 31%;
one or more shapes of copper-containing particles blended within the polymer matrix at a concentration, by weight, of between 25% and 56%; and
one or both of solder flux and density-lowering particles blended into the polymer matrix;
wherein the tin-containing particles and the copper-containing particles have intermetallic phases from metal-metal diffusion of the tin-containing particles and the copper-containing particles being blended at a temperature within the intermetallic annealing temperature range for the tin-containing particles and the copper-containing particles.
